(19) United States
(12) Patent Application Publication
(10) Pub. No.: US 2010/0148405 A1
(43) Pub. Date: Jun. 17, 2010

(54) NANOFIBER PRODUCING METHOD AND NANOFIBER PRODUCING APPARATUS

(76) Inventors: Hiroto Sumida, Nara (JP); Takahiro Kurokawa, Tokyo (JP); Kazunori Ishikawa, Osaka (JP); Mitsuhiro Takahashi, Ehime (JP); Mikio Takezawa, Kagawa (JP); Yoshiaki Tominaga, Kanagawa (JP)

Correspondence Address: WENDEROTH, LIND & PONACK L.L.P., 1030 15th Street, N.W., Suite 400 East, Washington, DC, 20005-1503, US

(21) Appl. No.: 12/600,938

(22) PCT Filed: May 12, 2008
(86) PCT No.: PCT/JP2008/001185

§ 371 Date: Nov. 19, 2009

(30) Foreign Application Priority Data
May 21, 2007 (JP) 2007-133856
Feb. 14, 2008 (JP) 2008-033667

(51) Int. Cl. B29C 47/00; B29C 35/08

(52) U.S. Cl. 264/465; 425/174.6; 977/762

(57) ABSTRACT

An object of the present invention is to stabilize the properties of nanofibers produced.

Solution prepared by dissolving a polymeric substance in a solvent is supplied into a conductive ejection container having a plurality of ejection holes. The ejection container is rotated and electrostatic explosions of the solution discharged through the ejection holes are caused so that nanofibers are produced. In the above method for producing nanofibers, in the case where the amount of the solution contained in the ejection container exceeds a predetermined amount, the amount of the solution exceeding the predetermined amount overflow the ejection container. The overflowed solution is collected and resupplied to the ejection container.

### TECHNICAL FIELD

The present invention relates to a method and an apparatus for producing nanofibers made of polymeric substances.

### BACKGROUND ART

Conventionally, electrospinning (electric charge induced spinning) is known as a method for producing filamentous (fibrous form) substances (nanofibers) made of polymeric substances and such and having a diameter in a submicron order.

In the electrospinning method, nanofibers are produced by ejecting (discharging), to a space, solution which is raw material liquid prepared by dispersing or dissolving polymeric substances and such in solvent, applying an electric charge to the solution for charging, and allowing the solution traveling in the space to be electrostatically exploded.

More specifically, as the solvent evaporates from particles of the solution traveling the space, volume of the solution decreases. On the other hand, the electric charge applied to the solution remains, which results in increasing charge density of the particles of the solution. Since the solvent continuously evaporates, the charge density of the particles of the solution further increases. When Coulomb force, which is generated in the solution particles and acts oppositely, exceeds the surface tension of the solution, polymer solution undergoes a phenomenon in which the polymer solution is explosively stretched into filament (electrostatic explosion). Such electrostatic explosion is repeatedly generated in the space, thereby producing nanofibers made of polymers with a submicron diameter (for example, see patent reference 1).

By depositing thus produced nanofibers on a substrate or the like, a thin film having 3-D structure of 3-D mesh can be obtained. Further, by depositing the nanofibers thicker, a highly porous web having submicron mesh can be produced. Thus produced thin film and highly porous web can be preferably applied to a filter, a separator for use in a battery, a polymer electrolyte membrane or an electrode for use in a fuel cell, or the like. Such applications of the highly porous web made of the nanofibers are expected to significantly improve performances of those devices.

However, since, in the conventional electrospinning method, only a small amount of nanofibers can be produced from the tip of a single nozzle, the productivity of nanofibers cannot be improved. Consequently, as a method for producing a large amount of nanofibers, a method utilizing a plurality of nozzles has been proposed (for example, see patent reference 2).

With reference to FIG. 1, the structure of an apparatus for producing a polymeric web described in the patent reference 2 is described as follows. A liquid polymeric substance in a barrel 43 is supplied to a spinning unit 42 having a plurality of nozzles 41 by a pump 44. A high voltage of from 5 to 50 kV is applied to the nozzles 41 by a high voltage generating unit 45. Fibers discharged through the nozzles 41 are deposited on a collector 46 that is either grounded or charged to a polarity different from that of the nozzles 41 to form a web. The formed web is transported by the collector 46, and a polymeric web is produced, accordingly. It is also described in the reference that a charge distributor 47 is provided in the vicinity of the tips of the nozzles 41 to minimize electrical interference among the nozzles 41 and that a high voltage is applied to between the charge distributor 47 and the collector 46 so that an electric field which urges the charged fibers towards the collector 46 is created.

Furthermore, as shown in FIGS. 2 (a) and (b), it is also described in the reference that, instead of providing a plurality of single nozzles, a plurality of multi-nozzles 41A, each including a plurality of nozzles 41, are provided to the spinning unit 42 such that a plurality of nanofibers are produced from each of the multi-nozzles 41A.

### Patent Reference 1: Japanese Unexamined Patent Application Publication No. 2005-330624

### Patent Reference 2: Japanese Unexamined Patent Application Publication No. 2002-201559

### DISCLOSURE OF INVENTION

### Problems that Invention is to Solve

In order to produce the nanofibers with an improved productivity using the structure shown in FIG. 1 and FIG. 2, it is conceivable that the nozzles 41 in the spinning unit 42 or the nozzles 41 in each multi-nozzle 41A are provided at smaller intervals so that the number of nozzles per unit area is increased. In this case, however, as shown in FIG. 3, the polymeric substances discharged through each nozzle 41 repel each other as indicated by arrows F since the polymeric substances are charged of the same polarity. Consequently, the discharge from the nozzles 41 located in the middle is hampered. Further to this, the discharge from the nozzles 41 located at a peripheral area is directed outward. As a result, the deposition distribution of nanofibers on the collector 46 becomes extremely sparse at the central area and concentrated at the peripheral area, thereby failing to produce a uniform polymeric web.

If the charge distributor 47 is provided in the vicinity of the tips of the nozzles 41, electrical interference among the nozzles 41 is reduced as shown in FIG. 4. In addition to this, the polymeric substances discharged through each of the nozzles 41 is accelerated toward the collector 46 because an electric field E from the charge distributor 47 to the collector 46 is created. As a result, as compared to the case of FIG. 3, the deposition distribution of nanofibers at the central area and at the peripheral area can be uniformed to a certain extent. However, at the same time, the disposition pattern of the nozzles 41 is directly reflected in the deposition distribution. Therefore, the above-mentioned arrangement is not sufficiently effective in uniforming the deposition distribution.

Furthermore, if provision density of the nozzles 41 is raised, fibers may come to be in contact each other and stick together without sufficiently evaporating the solvent. In addition to this, the concentration of the evaporated solvent may increase in the vicinity of the nozzles so that the insulation weakens, and accordingly, corona discharge takes place, thereby failing to form fibers.

Furthermore, if a number of nozzles 41 are to be provided, it is difficult to supply a liquid polymeric substance evenly to each of the nozzles 41. This may complicate the structure of the apparatus and raise the cost of facility. In addition to this, in order to cause an electrostatic explosion of the liquid polymeric substance discharged through the nozzles 41, the electric charge needs to be concentrated, and, accordingly, each of the nozzles 41 is formed in a long and narrow shape. However, it is also extremely difficult to conduct the maintenance on a number of long and narrow nozzles 41 in order to ensure that they are constantly in a proper condition.

Thus, the applicant of the present invention previously proposed the following structure (see patent reference: Japanese Patent Application No. 2006-317003). As shown in FIG. 5, a rotary tube 53 is fixed coaxially to one end of a conductive cylindrical container 51 having a plurality of ejection holes 52 on its circumferential surface, such that the rotary tube 53 is pivotally supported. A solution supplying unit 54 supplies solution as raw material liquid 50 into an ejection container 51 through a solution supply tube 55 inserted to the rotary tube 53. Then, the rotary tube 53 is driven to rotate so as to rotate the rotary container 51, and the ejection container 51 is charged by a first high voltage generating unit 56. As a result, filamentous solution discharged through the ejection holes 52 are stretched by centrifugal force and an electrostatic explosion induced by evaporation of solvent, thereby producing nanofibers made of polymeric substances. In addition, a voltage with a polarity identical to that of the ejection container 51 is applied by a reflecting power source 58 to a reflecting electrode 57 provided at a certain distance from one end of the axial direction of the ejection container 51, so that the produced nanofibers are deflected and travel toward the other end of the axial direction of the ejection container 51. Then, a voltage with an electric potential different from that of the charge of the ejection container 51 is applied, by a third high voltage generating unit 60, to a conductive collector 59 provided at a certain distance from the other side of the axial direction of the ejection container 51, so that the nanofibers are deposited on the collector 59.

However, the following problem has been found in the structure shown in FIG. 5. In order to continuously maintain stable centrifugal force that acts on the solution 50 extruded through the ejection holes 52 of the cylindrical container 51 and to discharge the solution 50 as filaments evenly for producing uniform nanofibers, it is necessary to detect the amount of the solution 50 contained in the ejection container 51 and to precisely control the solution supplying unit 54 such that an almost constant amount of the solution 51 is always contained in the ejection container 51. This results in complicating the structure, and raising required costs.

The present invention is to solve the conventional problems described above, and has an object to provide a method and an apparatus for producing uniform nanofibers with high productivity using a simple structure.

### Means to Solve the Problems

A nanofiber producing method according to an aspect of the present invention is a nanofiber producing method including: supplying solution which is raw material liquid into an ejection container which is conductive and has a plurality of ejection holes, the raw material liquid being prepared by dissolving a polymeric substance in a solvent; and rotating the ejection container so that the solution discharged through the plurality of ejection holes is electrostatically exploded, the nanofiber producing method comprising, in the case where an amount of the solution contained in the ejection container exceeds a predetermined amount: allowing an amount of the solution exceeding the predetermined amount to overflow the ejection container; collecting the solution which has overflowed; and resupplying the solution which has been collected to the ejection container.

It should be noted that, in the present invention, in order to apply an electric field to the filamentous solution discharged through the ejection holes of the ejection container, a large potential difference is applied between the ejection container and an object or a member that constitutes a space for producing nanofibers. For example, when such an object or a member that constitutes a space for producing nanofibers is either the earth or a member such as the collector grounded to the earth, a positive or negative high voltage with reference to the ground potential is applied to the ejection container. When a high voltage that is either positive or negative with reference to the ground potential is applied to a member such as the collector that constitutes a space for producing nanofibers, the ejection container may be grounded. The ejection holes are not limited to those directly punched through the circumferential wall of the ejection container. Needless to say, the ejection holes may be provided by nozzles installed on the circumferential wall of the ejection container.

According to the structure described above, the solution is discharged through the ejection holes of the ejection container under the influence of the centrifugal force and is electrically charged. At this time, the solution stably discharged through the ejection holes is stretched under the influence of the centrifugal force.

Further, electrical interference hardly occurs by rotating the ejection container. This is because the solution discharged through the adjacent ejection holes by the centrifugal force, travel not in parallel to each other, but radially. More specifically, the solution with same polarity travel gradually departing each other, which results in hardly causing electrical interference.

As described, since electrical interference does not affect the condition, the solution can be stretched reliably and effectively even if the ejection holes are densely provided.

Then, the diameter of the stretched solution decreases due to the evaporation of the solvent, and the charge density increases. At the time when Coulomb force exceeds the surface tension, a primary electrostatic explosion takes place in the solution. Then the polymer solution is further stretched. As the evaporation of the solvent proceeds further, a secondary electrostatic explosion takes place in a similar manner and the polymer solution is explosively stretched. A tertiary electrostatic explosion may take place, depending on the situation.

Accordingly, a large amount of nanofibers made of polymeric substances and having a submicron diameter can be efficiently produced from solution discharged as filaments through a plurality of ejection holes, using a simple and compact structure.

Furthermore, since the solution discharged through the ejection holes is first stretched by the centrifugal force, those small holes need not be made to be extremely small. In addition, the ejection holes do not need to be made of a long shape to concentrate the charges as described above. Thus, it is only necessary that the ejection container be simply provided with ejection holes. Hence, the ejection container can be fabricated easily and at low costs. The maintenance can still be conducted easily even though the ejection container is provided with a large number of ejection holes.

Furthermore, an amount of the solution exceeding a predetermined amount in the ejection container overflows the ejection container. Thus, a constant amount of solution can be continuously maintained in the ejection container by simply supplying sufficient amount of solution to the ejection container. Accordingly, it is possible to maintain constant centrifugal force acting on the solution extruded through the ejection holes of the ejection container, thereby reliably producing uniform nanofibers.

Furthermore, the solution overflowed the ejection container is collected and transported to the ejection container again so that the overflowed solution can be reused. As a result, the solution is not unnecessarily consumed.

With above, production of uniform nanofibers with high productivity is possible while realizing a cost reduction associated with apparatuses and materials.

Further, it may be that the ejection container is a cylindrical container and has the plurality of ejection holes on a circumferential wall, and the method further includes allowing the amount of the solution exceeding the predetermined amount to overflow through a weir which has an annular shape and is provided at one end of the ejection container.

By having the ejection container which is a cylindrical container and has the plurality of ejection holes on a circumferential wall, and allowing the amount of the solution exceeding the predetermined amount to overflow through a weir which has an annular shape and is provided at one end of the ejection container, a large amount of nanofibers can be uniformly produced from the whole circumference of the cylindrical container at once, which secures high productivity. In addition, by allowing the amount of the solution exceeding the predetermined amount to overflow through a weir which has an annular shape and is provided at one end of the ejection container, the above advantageous effects can be obtained with an extremely simple structure.

On the other hand, in order to achieve the above object, the nanofiber producing apparatus according to an aspect of the present invention is a nanofiber producing apparatus including: an ejection unit which ejects solution which is raw material liquid for nanofibers; and a charging unit which charges the solution by applying an electric charge to the solution, in which the ejection unit includes: an ejection container which has a cylindrical shape with an ejection hole on a circumferential wall and ejects the solution contained inside by a centrifugal force caused by rotation of the ejection container; a solution storage unit which stores the solution to be transported to the ejection container, and to store the solution which has overflowed the ejection container; and a transporting unit which transports the solution from the solution storage unit to the ejection container.

With this structure, an amount of the solution exceeding a predetermined amount in the ejection container overflows the ejection container. Thus, by simply supplying sufficient amount of solution to the ejection container, constant amount of solution can be continuously maintained in the ejection container, and constant centrifugal force which acts on the solution contained in the ejection container can also maintained. Accordingly, uniform nanofibers can constantly be produced.

Further, since the overflowed solution can be collected and reused, the solution is not unnecessarily consumed. This allows production of uniform nanofibers with high productivity while realizing a cost reduction associated with apparatuses and materials.

It is preferable that the ejection container includes a weir which has an annular shape and is provided on an inner circumferential surface of an end of the ejection container, the weir projecting inward the ejection container.

Further, by having the ejection container which is a cylindrical container and has the plurality of ejection holes on a circumferential wall, it is possible to uniformly produce a large amount of nanofibers from the whole circumference of the cylindrical container at once, which secures high productivity. Further, at one end of the ejection container, an annular weir through which the amount of the solution exceeding the predetermined amount to overflow, is provided. With this, when the solution is supplied to the ejection container exceeding the predetermined amount, the exceeding amount of the solution overflows through the annular weir provided at one end of the ejection container. In other words, by simply supplying a sufficient amount of the solution, a constant and desired amount of the solution can be maintained in the ejection container. Accordingly, the centrifugal force acts on the solution extruded through the ejection holes of the ejection container can be maintained at a desired value, thereby controlling the quality of the nanofibers to a certain extent.

Further, a gas flow generating unit may also be provided at a distance from the ejection container in an axial direction of the ejection container.

With this, blowing from one end of the axial direction of the ejection container allows effective deflection of the direction of travel of the nanofibers which are being produced. Further, evaporated solvents are moved out of the manufacturing space immediately, which results in not increasing solvent concentration in the surrounding atmosphere. This facilitates solvent evaporation, and reliably produces effects of the electrostatic explosion, thereby reliably producing desired nanofibers.

Further, the nanofiber producing apparatus may also include a windshield case, inside which the solution storage unit and the transporting unit can be provided, and which prevents gas flow generated by the gas flow generating unit from flowing into inside of said windshield case.

With this, it is possible to transport nanofibers and the like with gas flow. This also allows the nanofibers and the like to be collected by gas flow. As a result, it is possible to collect the nanofibers with high density. Further, the windshield case isolates circulating solution from the gas flow; and thus, solvent evaporation is not easily accelerated by the gas flow. Thus, it is possible to obtain the stable quality of the solution. Further, in this case, the solution storage unit and the transporting unit are provided near the ejection container; and thus, minimizing degradation of the solution is possible.

### EFFECTS OF THE INVENTION

According to a nanofiber producing method and a nanofiber producing apparatus of the present invention, a large amount of nanofibers made of polymeric substances and having a submicron diameter can be efficiently produced from solution as raw material liquid discharged through a plurality of ejection holes, using a simple and compact structure. Furthermore, since the solution discharged through the ejection holes is first stretched by the centrifugal force, the ejection holes need not be made to be extremely small. The ejection holes do not also need to be made of a long shape to concentrate the charges as described above. Thus, it is only necessary that the ejection container be simply provided with ejection holes. Accordingly, the ejection container can be fabricated easily and at low costs, and the maintenance can be conducted easily even though the ejection container is provided with a large number of ejection holes.

Furthermore, the amount of the solution exceeding a predetermined amount in the ejection container overflows the ejection container. Thus, a constant amount of solution can be continuously maintained in the ejection container by simply supplying sufficient amount of solution to the ejection container. Accordingly, it is possible to maintain constant centrifugal force that acts on the solution extruded through the ejection holes of the ejection container, thereby constantly producing uniform nanofibers. In addition, the overflowed solution is collected and resupplied to the ejection container, so that the overflowed solution is reused. This prevents the solution from being unnecessarily consumed. Therefore, production of uniform nanofibers with high productivity is possible while realizing a cost reduction associated with apparatuses and materials.

Further, according to the present invention, the solution circulates between the ejection container and the solution storage unit provided near the ejection container. This prevents the degradation of the solution due to circulation of the solution. Therefore, it is possible to obtain stable quality of nanofibers produced from the solution.

### BRIEF DESCRIPTION OF DRAWINGS

FIG. 1 is a schematic structure of an apparatus for producing a polymeric web according to a conventional example.

FIG. 2 shows essential parts of another example of a structure of the conventional example, (a) being a front view, and (b) being a partially enlarged bottom view.

FIG. 3 is a diagram illustrating problems faced in the conventional example.

FIG. 4 is a diagram illustrating still other problems faced in the conventional example.

FIG. 5 is a longitudinal front view of a nanofiber producing apparatus disclosed prior to the present invention.

FIG. 6 is a longitudinal front view of a nanofiber producing apparatus according to a first embodiment of the present invention.

FIG. 7 is a perspective view of a producing state of a polymeric web according to the first embodiment of the present invention.

FIG. 8 is a block diagram showing a control structure according to the first embodiment of the present invention.

FIG. 9 is a longitudinal front view of a nanofiber producing apparatus according to a second embodiment of the present invention.

FIG. 10 is a perspective view of a producing state of a polymeric web according to the second embodiment of the present invention.

FIG. 11 is a longitudinal front view of a nanofiber producing apparatus according to a third embodiment of the present invention.

FIG. 12 is a cross sectional view schematically showing a nonwoven fabric producing apparatus according to an embodiment of the present invention.

FIG. 13 is a cross-sectional view of a raw material discharging unit.

FIG. 14 is a perspective view of an appearance of an ejection unit.

FIG. 15 is a cross-sectional view of a variation of the ejection unit.

FIG. 16 is a cross-sectional view of another variation of the ejection unit.

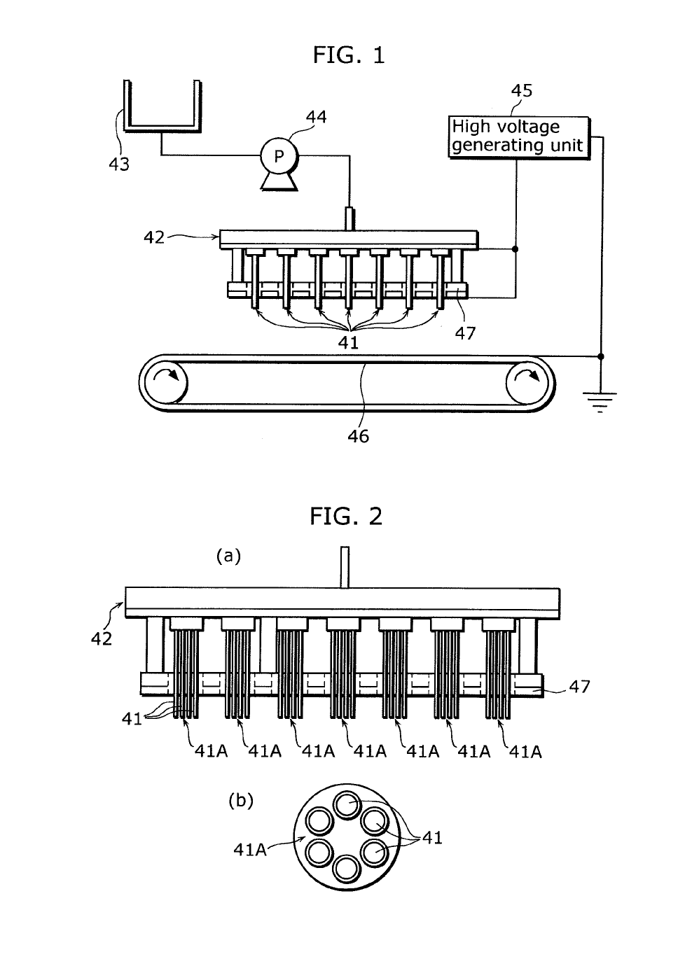

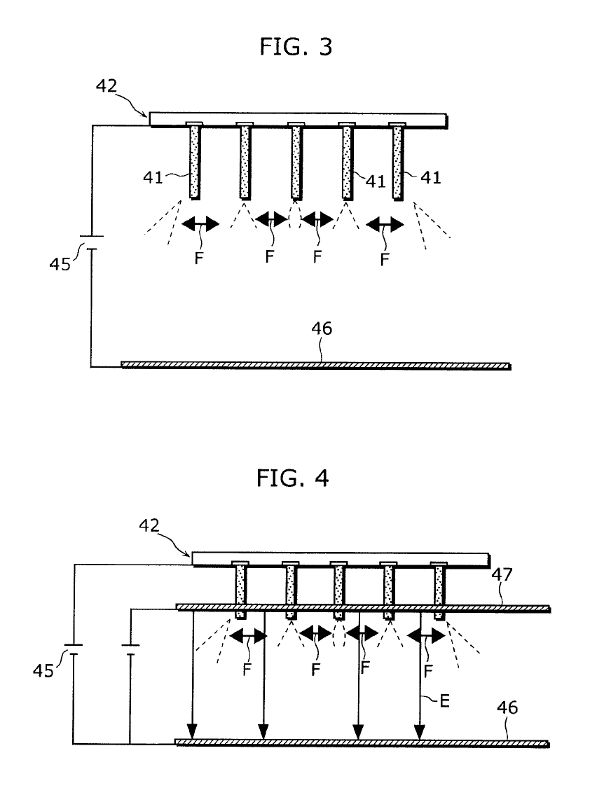

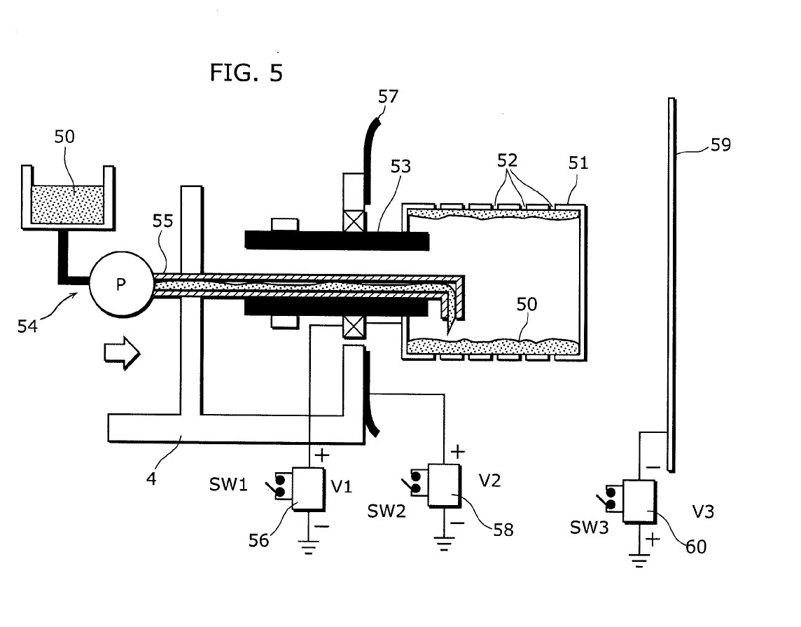

### NUMERICAL REFERENCES

f Nanofiber
1 Ejection container
2 Cylinder
3 Ejection hole
4 Support frame
5 Bearing
6 Pulley
7 Motor pulley
8 Belt
9 Motor
10 Solution supply tube
10a discharging portion
11 Solution as raw material liquid
12 Solution storage unit
13 Receiving unit
13a Return tube
14 Suction tube
15 Transporting pump
16 Charge power source
17 Conductive member
19 Reflecting power source
20 Collector
21 Collector power source
22 Control unit
23 Operation unit
24 Memory unit
25 Display unit
26 Storage container
27 Transporting tube
31 Weir
32 Rotary shaft
33 Support cylinder
34 Bearing
35 Solution surface sensor
36 Refill apparatus
37 Supply tube
38 Gas flow generating unit
41 Reflecting electrode
100 Nanofiber producing apparatus
102 Attracting unit
103 Area control unit
104 Transporting unit
105 Attraction control unit
106 Solvent collect unit
111 Supply roll
121 Duct
200 Discharging unit
201 Ejection unit
202 Charging unit
204 Solution supplying unit
205 Heating unit
206 Guiding body
207 Charge neutralization unit
215 Transporting unit
216 Windshield case
221 Induction electrode
223 Grounding unit
232 Second gas flow generating unit
223 Gas flow inlet
241 Solution supplying source
242 Adjustment valve
243 pump
244 Supply tube
262 Support body
265 Air tunnel
283 Insertion hole
290 Solution discharging unit
291 Solution amount detecting unit
292 Supply amount control unit

### BEST MODE FOR CARRYING OUT THE INVENTION

Hereinafter, embodiments of a nanofiber producing method and a nanofiber producing apparatus according to the present invention will be described with reference to the drawings.

### First Embodiment

Firstly, a first embodiment of a nanofiber producing apparatus according to the present invention will be described.

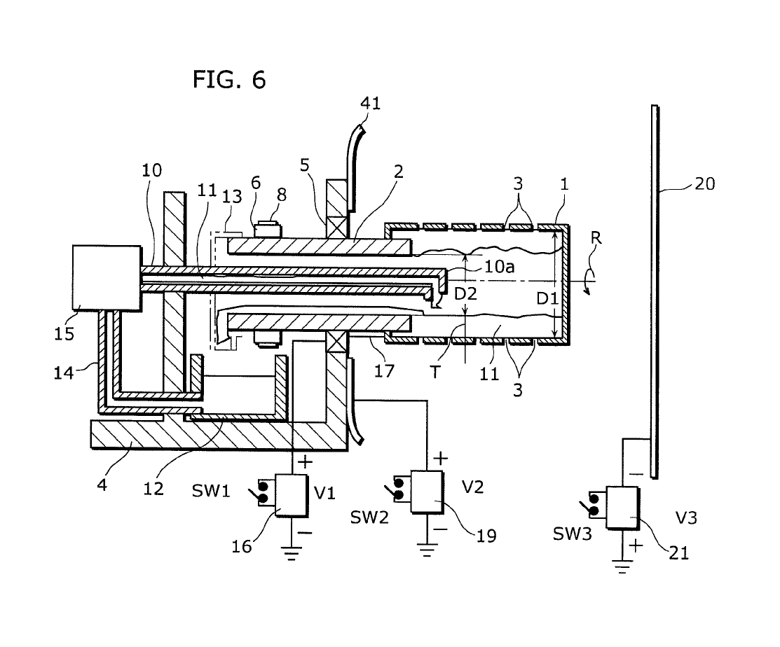

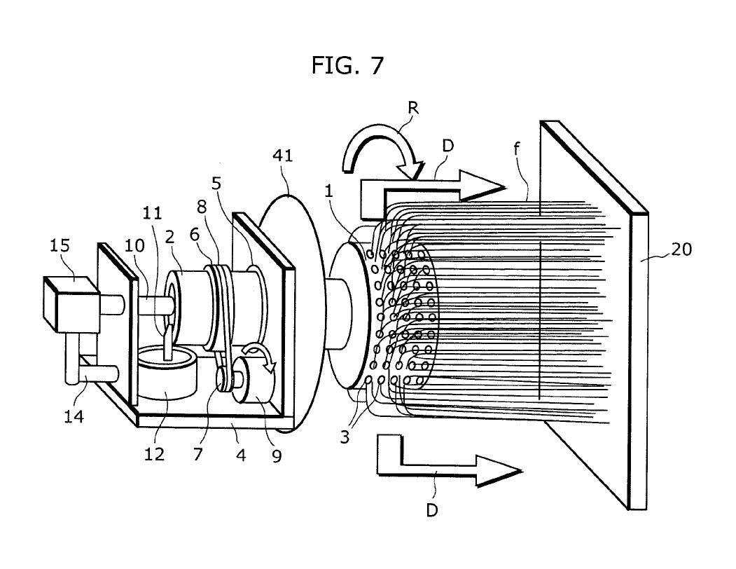

As shown in FIGS. 6 and 7, an ejection container 1 is a cylindrical container having a diameter of 30 to 400 mm. The ejection container 1 is integrally and coaxially fixed to a cylinder 2 such that one end of the cylinder 2 penetrates one end of central axis of the ejection container 1. Accordingly, the ejection container 1 is pivotally supported about the central axis by the cylinder 2 as shown by an arrow R. The cylinder 2 is made of materials with high electric insulating properties. The other end of the ejection container 1 is closed. A number of ejection holes 3 of 0.01 to 2 mm in diameter are provided on the circumferential surface of the ejection container 1 at intervals of a few millimeters.

The ejection holes 3 may be formed by directly punching through the circumferential wall of the ejection container 1; however, it may be that short nozzles each having a hole serving as the ejection hole are installed on the circumferential wall of the ejection container 1.

The cylinder 2 is pivotally supported via a bearing 5 by a support frame 4 made of materials with high electric insulating properties. The cylinder 2 is driven to rotate at a rate of 30 to 10000 rpm by a motor 9 serving as a rotation drive unit, via a belt 8 which is wound around between a pulley 6 provided on the outer circumferential surface of the cylinder 2 and a motor pulley 7 provided on the output axis of the motor 9.

A preferable motor to be used as the motor 9 is a sensorless DC motor, because a sensor may improperly operate under influence of high voltage noise.

A solution supply tube 10 as a transporting unit is inserted to the ejection container 1 through the center of the cylinder 2. The tip of the solution supply tube 10 is a discharging portion 10a which is a curved L-shaped toward bottom. Solution 11 prepared by dissolving, in a solvent, polymeric substances which are materials for nanofibers, is supplied into the ejection container 1 via the solution supply tube 10. By supplying the solution 11 into the ejection container 1 and rotating the ejection container 1, the excessively supplied solution 11 overflows to the outside through the cylinder 2 while the inner circumferential surface of the cylinder acting as a weir. As a result, a layer of the solution 11 with even thickness is formed on the whole inner circumferential surface of the ejection container 1. More particularly, where the inside diameter of the ejection container 1 is D1, and the inside diameter of the cylinder 2 is D2, a layer of the solution 11 with approximately uniform thickness of T=(D1-D2)/2 is formed on the inner circumferential surface of the ejection container 1.

A solution storage unit 12, which serves as a collecting unit, is provided above the support frame 4, so that the solution 11 overflowed to the outside through the cylinder 2 are collected. As indicated by a virtual line in FIG. 6, a receiving unit 13 is provided which receives the solution 11 overflowed the cylinder 2 and guides the solution 11 to the solution storage unit 12 while preventing the solution from dispersing. Further, an amount of the solution 11 equivalent to the amount of the solution 11 which has been consumed is refilled to the solution storage unit 12 by a solution refill unit (not shown). The solution 11 in the solution storage unit 12 is suctioned through a suction tube 14 by a transporting pump 15 serving as a transporting unit, and is transported toward the ejection container 1 through the solution supply tube 10 at a predetermined flow rate.

Examples of polymeric substances constituting the solution 11 include polypropylene, polyethylene, polystyrene, polyethylene oxide, polyethylene terephthalate, polybutylene terephthalate, polyethylene naphthalate, poly-m-phenylene terephthalate, poly-p-phenylene isophthalate, polyvinylidene fluoride, polyvinylidene fluoride-hexafluoropropylene copolymer, polyvinyl chloride, polyvinylidene chloride-acrylate copolymer, polyacrylonitrile, polyacrylonitrile-methacrylate copolymer, polycarbonate, polyarylate, polyester carbonate, nylon, aramid, polycaprolactone, polylactic acid, polyglycolic acid, collagen, polyhydroxybutyric acid, polyvinyl acetate, and polypeptide. Although at least one type selected from the above is used, the present invention should not be limited thereto.

Solvents that can be used include methanol, ethanol, 1-propanol, 2-propanol, hexafluoroisopropanol, tetraethylene glycol, triethylene glycol, dibenzyl alcohol, 1,3-dioxolane, 1,4-dioxane, methyl ethyl ketone, methyl isobutyl ketone, methyl-n-hexyl ketone, methyl-n-propyl ketone, diisopropyl ketone, diisobutyl ketone, acetone, hexafluoroacetone, phenol, formic acid, methyl formate, ethyl formate, propyl formate, methyl benzoate, ethyl benzoate, propyl benzoate, methyl acetate, ethyl acetate, propyl acetate, dimethyl phthalate, diethyl phthalate, dipropyl phthalate, methyl chloride, ethyl chloride, methylene chloride, chloroform, o-chlorotoluene, p-chlorotoluene, carbon tetrachloride, 1,1-dichloroethane, 1,2-dichloroethane, trichloroethane, dichloropropane, dibromoethane, dibromopropane, methyl bromide, ethyl bromide, propyl bromide, acetic acid, benzene, toluene, hexane, cyclohexane, cyclohexanone, cyclopentane, o-xylene, p-xylene, m-xylene, acetonitrile, tetrahydrofuran, N,N-dimethylformamide, pyridine, and water. Although at least one type selected from the above is used, the present invention should not be limited thereto.

The solution can be mixed with an inorganic solid material, examples of which include oxides, carbides, nitrides, borides, silicides, fluorides, and sulfides. However, in terms of thermal stability, workability, and the like, oxides are preferable. Examples of oxides include Al₂O₃, SiO₂, TiO₂, Li₂O, Na₂O, MgO, CaO, SrO, BaO, B₂O₃, P₂O₅, SnO₂, ZrO₂, K₂O, Cs₂O, ZnO, Sb₂O₃, As₂O₃, CeO₂, V₂O₅, Cr₂O₃, MnO, Fe₂O₃, CoO, NiO, Y₂O₃, Lu₂O₃, Yb₂O₃, HfO₂, and Nb₂O₅. Although at least one type selected from the above is used, the present invention should not be limited thereto.

Desirable mixing ratio of solvent and polymeric substance is that the polymeric substances constituting the nanofiber be selected in the range of not less than 1 vol % and not more than 50 vol %, and the corresponding solvent be selected in the range of not less than 50 vol % and not more than 99 vol %.

A high voltage of 1 kV to 200 kV, preferably 10 kV to 100 kV, generated by a charge power source 16 serving as a charging unit, is applied to the ejection container 1 via the bearing 5, and a conductive member 17. Accordingly, the solution 11 contained in the ejection container 1 is also subject to this high voltage. As a method for applying a high voltage, a high voltage may be applied to the ejection container 1 by the charging unit via a slip ring or a brush.

When the ejection container 1 is driven to rotate at a high speed by the mortor 9, centrifugal force acts on the solution 11. Then, the solution 11 is discharged as filaments through each of the ejection holes 3. The filaments of the solution 11 are then stretched under the influence of the centrifugal force, thereby producing thin filamentous solution. The filamentous solution to which the high voltage is applied, is then subjected to an electric field that is formed around the ejection container 1, and is electrically charged. When the solvent of the solution 11 evaporates, the diameter of the polymeric filament decreases. With this, the density of the electric charge residing thereon becomes concentrated. When Coulomb force exceeds the surface tension of the solution 11, a primary electrostatic explosion takes place, and the solution 11 is explosively stretched. Then, as the solvent further evaporates, a secondary electrostatic explosion takes place, and the solution 11 is further stretched explosively in a similar manner. Depending on the condition, a tertiary electrostatic explosion and so on may take place. Consequently, nanofibers f that have submicron diameters and are made of polymeric substances are effectively produced.

A reflecting electrode 41 is provided to the support frame 4 so as to be positioned directly opposite to one end of the ejection container 1 with a suitable distance. A high voltage generated by a reflecting power source 19 is applied to the reflecting electrode 41. The reflecting power source 19 generates a high voltage with the polarity identical to that of charge power source 16 and approximately same level, and applies the generated voltage to the reflecting electrode 41. As shown in FIG. 7, the reflecting electrode 41 causes the filamentous solution produced by being discharged from the ejection container 1 and stretched, and the nanofibers f produced by the successively generated electrostatic explosion, to travel toward the other end of the ejection container 1 as indicated by the arrow D.

A conductive collector 20 is provided so as to be directly opposite to the other end of the ejection container 1 with a suitable distance. A high voltage, which is generated by a collector power source 21 and has a polarity opposite to that of the voltage applied to the ejection container 1, is applied to the collector 20.

Since it is only necessary that a large potential difference is created between the ejection container 1 or the reflecting electrode 41 and the collector 20 so that an electric field is generated therebetween. Thus, the collector 20 may be simply grounded.

With an electric field generated by a large potential difference between the ejection container 1 or the reflecting electrode 41 and the collector 20, the nanofibers f are produced as described above. Then, as shown in FIG. 7, the charged nanofibers f are caused to travel toward the collector 20 to be deposited thereon. By applying, to the collector 20, a high voltage with a polarity opposite to that of the ejection container 1, it is possible to allow the produced nanofibers f to be deposited on the collector 20 even when the ejection container 1 and the collector 20 are distant from each other by, for example, approximately 2 m.

It is preferable that the charge power source 16, the reflecting power source 19, and the collector power source 21 are respectively switched on and off as necessary by switches SW1, SW2, and SW3.

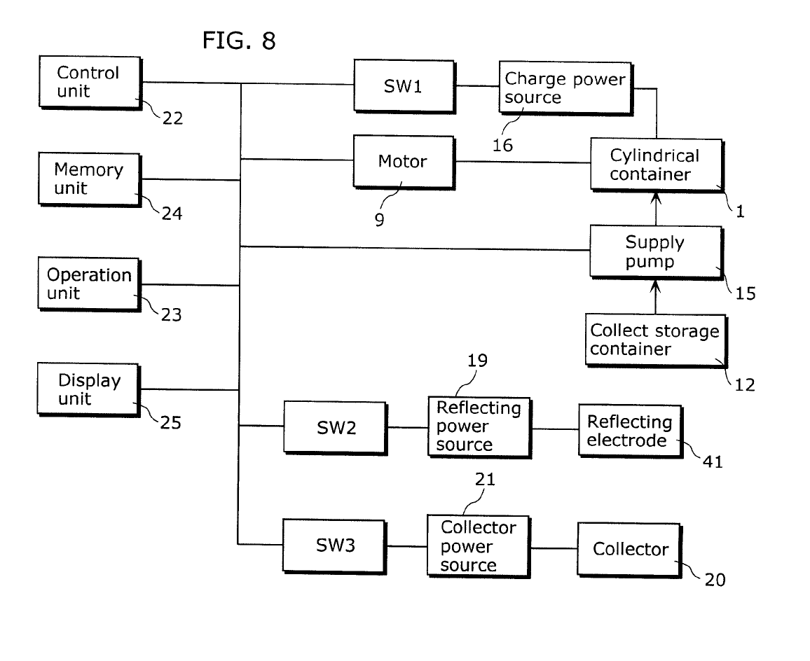

Next, control structure is described with reference to FIG. 8.

In the figure, a control unit 22 controls the motor 9, the transporting pump 15, the charge power source 16, the reflecting power source 19, and the collector power source 21. In accordance with an operational instruction from an operation unit 23, the control unit 22 controls operations based on operation programs stored in a memory unit 24 or various kinds of data inputted by the operation unit 23 and stored, and displays the operational status or various kinds of data onto a display unit 25.

With the above structure, a predetermined amount of the solution 11 is supplied to the ejection container 1 by the transporting pump 15, and a predetermined level of high voltage is applied to the ejection container 1 by the charge power source 16, so as to charge the solution 11 contained in the ejection container 1 to a high voltage. By rotating the ejection container 1 at high speed by the mortor 9 in such a state, the solution is discharged as filaments through the ejection holes 3 to become filamentous solution. The filamentous solution is then greatly stretched under the influence of the centrifugal force. Then, the filamentous solution charged to a high voltage is subjected to an electric field and are electrically charged. When the filamentous solution is further stretched making the diameter thereof decrease, and the solvent evaporates, the electric charge becomes concentrated. As a result, a primary electrostatic explosion takes place, thereby explosively stretching the filamentous solution. Then, as the solvent further evaporates, a secondary electrostatic explosion takes place, and the filamentous solution is further stretched explosively in a similar manner. Depending on the condition, a tertiary electrostatic explosion and so on takes place, thereby causing further stretching. Accordingly, the nanofibers f made of polymeric substances and having a submicron diameter can be produced from filamentous solution discharged through the ejection holes.

Here, a layer of the solution 11 with approximately uniform thickness T is formed on the inner circumferential surface of the ejection container 1. The solution 11 excessively supplied overflows to the outside through the cylinder 2 acting as a weir, and is collected by the solution storage unit 12 to be reused. As described, the amount of the solution 11 in the ejection container 1 can be controlled to be almost constant all the time; and thus, a constant centrifugal force acts on the solution 11 in the ejection container 1, and centrifugal force acts on the solution 11 discharged through the ejection holes 3 of the ejection container 1 also becomes constant. As a result, the solution 11 can be evenly discharged as filaments, thereby producing uniform nanofibers f.

Furthermore, when producing the nanofibers f, the filamentous solution is stretched under the influence of the centrifugal force. The direction of travel of the filamentous solution tends to be radial. However, the reflecting electrode 41 deflects the direction toward the other end of the axial direction of the ejection container 1. As a result, the produced nanofibers f can be easily collected within a predetermined area of the collector 20.

Furthermore, the reflecting electrode 41 is provided at a certain distance from the one end of the ejection container 1; and thus, unlike the case where the parabolic mirror type reflecting electrode 41 is provided facing the outer circumferential surface of the ejection container 1, the reflecting electrode 41 does not face the direction of discharge of the charged solution 11. As a result, the electric charge of the reflecting electrode 41 does not affect the discharge of the solution 11, thereby producing the nanofibers f stably and effectively.

Further, even if some solutions do not become fibers and remain as droplets, such droplets disperse by the centrifugal force. Only appropriate nanofibers f are deflected and travel toward the collector 20; and thus, only the nanofibers f with high quality can be collected.

Thus produced and electrically charged nanofibers f are deposited on the collector 20. Accordingly, a highly porous polymeric web can be produced with high productivity.

Further, since the solution filament, formed by being discharged through the ejection holes 3 of the ejection container 1, is stretched significantly by the centrifugal force, the ejection holes 3 can be made to be approximately 0.01 to 2 mm in diameter. Therefore, the ejection holes 3 do not need to be made extremely small. Furthermore, unlike the case where the electrostatic explosion needs to take place first, electric charge does not need to be concentrated; and thus, the ejection holes 3 do not need to be formed as a long and narrow nozzle. Furthermore, since the electric field interference does not affect the situation, even when the ejection holes 3 are densely arranged, the filamentous solution can be reliably and effectively stretched, thereby effectively producing a large amount of nanofibers in a simple and compact structure.

Furthermore, a large amount of nanofibers can be produced at a time evenly from the entire circumferential surface of the ejection container 1, ensuring high productivity. Its simple shape and structure also contribute to a cost reduction associated with production facilities. Furthermore, the ejection holes 3 may be provided at the tips of the nozzles. However, with the structure of the present invention, the ejection holes 3 do not need to be made of a long and narrow shape; and thus, these ejection holes 3 can be simply provided on the outer circumferential surface of the ejection container 1. Hence, the ejection container 1 can be fabricated easily and at low costs, and the maintenance can be conducted easily even though the ejection container 1 is provided with a large number of ejection holes 3.

Further, the motor 9 is capable of controlling the rotation speed of the ejection container 1 based on the viscosity of the solution 11 contained in the ejection container 1. This structure allows a required centrifugal force to act on the solution 11 in accordance with the viscosity of the solution 11, thereby reliably and effectively producing nanofibers f.

Further, in the above drawings, an example has been shown where the reflecting electrode 41 is fixed to the support frame 4 which is insulated from the ejection container 1, and a high voltage generated by the reflecting power source 19 is applied to the reflecting electrode 41. However, it may be that the reflecting electrode 41 is fixed to the outer circumferential surface of the cylinder 2, and is electrically connected to the ejection container 1, so that a same level of high voltage generated by the charge power source 16 is applied to the ejection container 1 and the reflecting electrode 41. In this case, the reflecting electrode 41 also rotates together with the ejection container 1, but this does not impose any functional effects.

Furthermore, it may be that a blowing unit which blows toward the other end of the ejection container 1 is provided between the reflecting electrode 41 and the ejection container 1. Accordingly, evaporated solvents are moved out of the manufacturing space immediately by blowing, which results in not increasing solvent concentration in the surrounding atmosphere. This facilitates solvent evaporation, and reliably produces effects of the electrostatic explosion, thereby reliably producing desired nanofibers f. Further, it also allows effective deflection of the direction of travel of the nanofibers f being produced. Further, it may be that instead of the reflecting electrode 41, a blowing unit which blows gas toward the other end of the ejection container 1 is provided so that the produced nanofibers can be deflected toward a desired direction.

Further, in the example of structure described above, the cylinder 2 can be driven to rotate, and the ejection container 1 is fixed to the cylinder 2. However, it may be that the cylinder 2 is fixed to the support frame 4, and the ejection container 1 is pivotally supported by the cylinder 2. In this case, the receiving unit 13 is not necessary.

### Second Embodiment

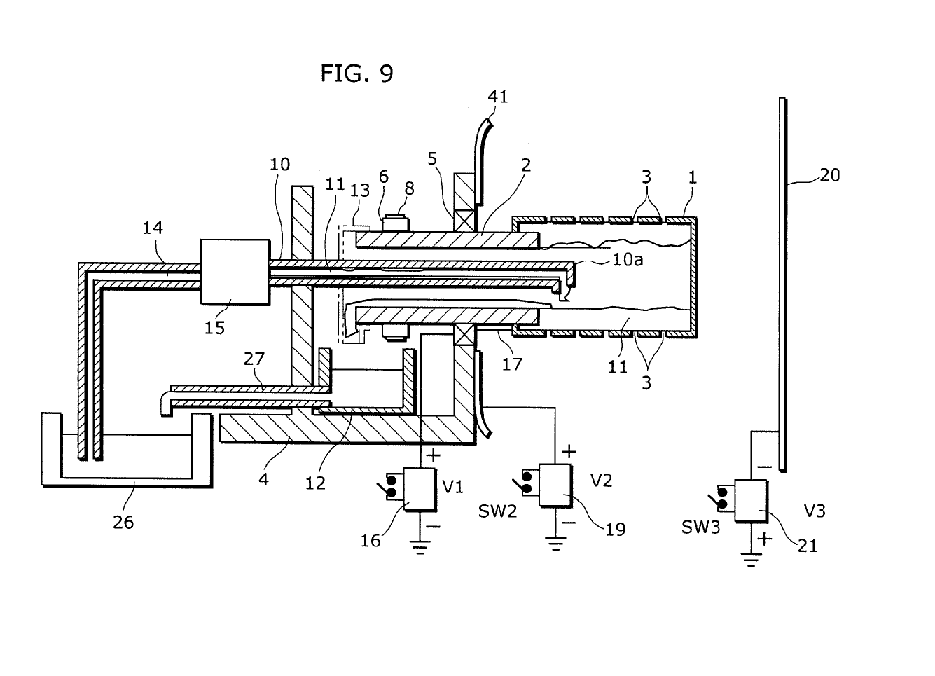

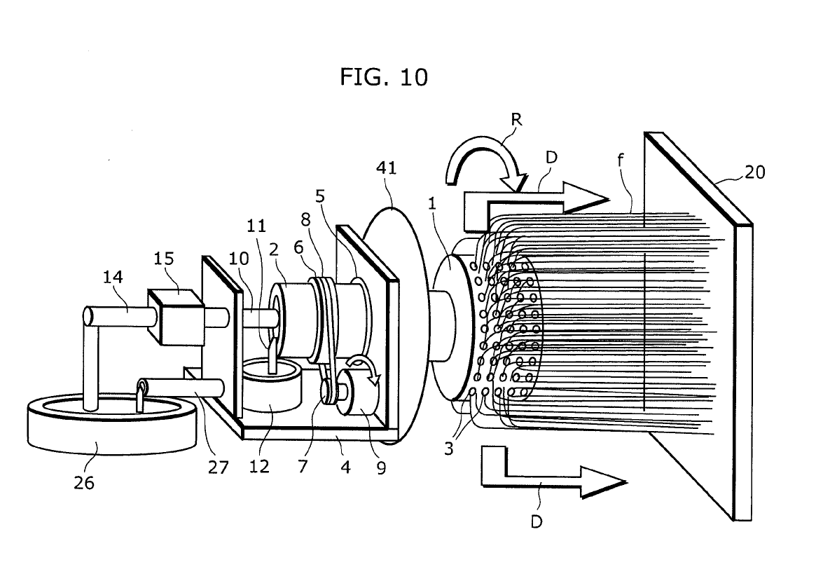

Next, second embodiment of a nanofiber producing apparatus according to the present invention will be described with reference to FIG. 9 and FIG. 10. In the following description of the embodiment, the same elements as appeared in the preceding embodiment will be designated by the same reference numerals, and descriptions of those elements will be omitted while only differences will be described.

In the above first embodiment, an example has been shown where solution 11 is suctioned by a transporting pump 15 through a suction tube 14 from a solution storage unit 12 provided above the support frame 4, and is transported into an ejection container 1. In the present embodiment, as shown in FIGS. 9 and 10, in addition to the solution storage unit 12, a large volumetric storage container 26 is provided, and the solution 11 collected into the solution storage unit 12 is transported to the storage container 26 through a transporting tube 27. The tip of the suction tube 14 connected to the suction inlet of the transporting pump 15 is inserted into the storage container 26.

The present embodiment can also produce the effects similar to those obtained in the first embodiment. In addition, since the excessive solution 11 overflowed the ejection container 1 is collected into the large volumetric storage container 26 via the solution storage unit 12 provided above the support frame 4, it is possible to stably supply the solution 11 from the storage container 26 into the ejection container 1.

### Third Embodiment

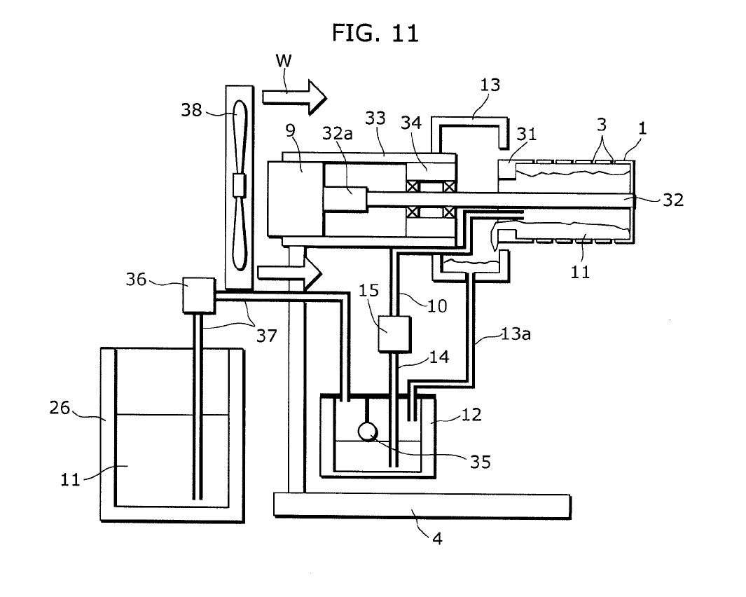

Next, third embodiment of a nanofiber producing apparatus according to the present invention will be described with reference to FIG. 11.

In the present embodiment, an ejection container 1 includes a weir 31 at its one end. Further, the ejection container 1 has an opening at the one end. A rotary shaft 32 penetrates the axial position of the ejection container 1 through the opening at the one end toward the other end of the ejection container 1 and is integrally connected to the closed wall at the other end. The rotary shaft 32 is pivotally supported by a shaft bearing 34 provided to a support cylinder 33 that is provided on a support frame 4. The rotary shaft 32 has a tip connected via a shaft coupling 32a to a motor 9 provided to the support cylinder 33, so that the rotary shaft 32 can be driven to rotate by the motor 9.

At the outer circumference of one end of the support cylinder 33, a receiving unit 13 is provided so as to surround the outer circumference of the one end of the ejection container 1. The receiving unit 13 has a return tube 13a for allowing the solution 11 collected inside the receiving unit 13 to return to a solution storage unit 12.

The solution 11 in the solution storage unit 12 is supplied into the ejection container 1 through a solution supply tube 10 by a transporting pump 15 such as a gear pump. Further, a liquid surface sensor 35 is provided for detecting a liquid surface level of the solution 11 in the solution storage unit 12. When it is detected that a liquid surface level is decreased to a certain level, the solution 11 is supplied by a refill apparatus 36 such as a gear pump, from the storage container 26 to the solution storage unit 12 through the supply tube 37 so that the liquid surface level of the solution 11 in the solution storage unit 12 can be maintained within an approximately constant range.

Further, a gas flow generating unit 38 is provided at a certain distance from the support cylinder 33 which is a position opposite to the ejection container 1. The nanofibers f, produced by being discharged from the ejection container 1 and stretched, are caused to travel toward the other end of the ejection container 1 by a gas flow W, which is generated by the gas flow generating unit 38 and indicated by an arrow, instead of causing the nanofibers f to travel toward the other end of the ejection container 1 by an electric field generated by the reflecting electrode 41.

It may be that a wire mesh form reflecting electrode 41 is provided around the outer circumferential surface of the support cylinder 33, such that both an electric field generated by the reflecting electrode 41 and the gas flow W cause the nanofibers f to travel toward the other end of the ejection container 1.

The present embodiment also produces the effects similar to those obtained in the first embodiment, and allows the compact structure of rotation mechanism of the ejection container 1. In addition, the excessive solution 11 in the ejection container 1 directly and smoothly overflows over the weir 31 at the one end of the ejection container 1, thereby maintaining constant thickness of the layer of the solution 11 in the ejection container 1 with high responsiveness. Further, it is possible to cause the nanofibers f produced from the ejection container 1 to smoothly travel toward the other end of the ejection container 1 by the gas flow W generated by the gas flow generating unit 38.

In the description of the above embodiment, an example has been described where either the reflecting electrode 41 or the gas flow generating unit 38 is provided, or both of them are provided. However, it may be that a collector 20, to which a high voltage with a polarity opposite to that of a voltage applied to the ejection container 1 is applied, or which is grounded, is simply provided so as to cause the nanofibers f produced from the ejection container 1 to travel toward the collector 20 and to deposit on the collector 20.

Furthermore, in the description of each embodiment above, an example has been described where a high voltage is applied to the ejection container 1 by the charge power source 16, and the collector 20 is grounded, or a voltage with an opposite polarity is applied to the collector 20 by the collector power source 21. However, it may be that a positive or negative high voltage is applied to the collector 20 by the collector power source 21 and the ejection container 1 is grounded.

### Fourth Embodiment

Next, fourth embodiment according to the present invention is described with reference to the drawings.

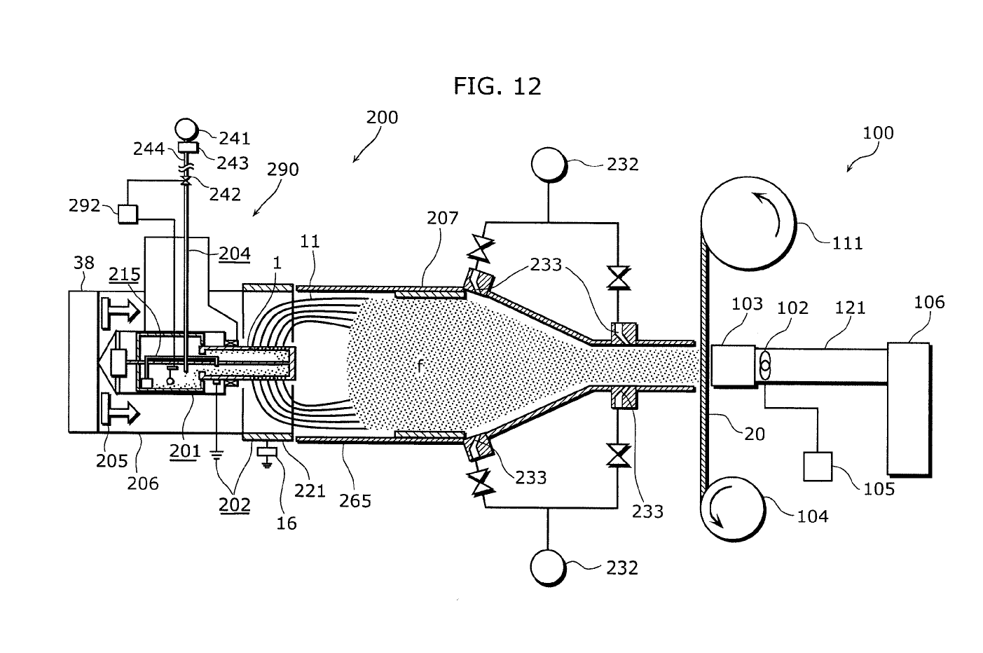

FIG. 12 is a cross sectional view schematically showing a nanofiber producing apparatus according to an embodiment of the present invention.

As shown in FIG. 12, a nanofiber producing apparatus 100 includes a nanofiber discharging apparatus 200, a collector 20, an attracting unit 102, an area control unit 103, a transporting unit 104, an attraction control unit 105, and a solvent collect unit 106.

The collector 20 is a member, on which nanofibers f produced in the air are deposited, and which has breathability so that the nanofibers f transported by the gas flow are collected. In the present embodiment, the collector 20 is a long sheet-shaped member which is thin and flexible, and made of materials easily removable from the deposited nanofibers f. More specifically, an example of the collector 20 is a long mesh made of aramid fiber. Further, Teflon (registered trademark) coating on its surface is preferable since it enhances removability of the collected nanofibers f. The collector 20 is supplied being wound into a roll from a supply roll 111.

The transporting unit 104 winds the long collector 20 and simultaneously unwinds the long collector 20 from the supply roll 111, and slowly moves the vicinity of the nanofiber discharging apparatus 200 so that the nanofibers f deposited on the collector 20 is transported. The transporting unit 104 can wind the nanofibers f deposited in a non-woven fabric like state, together with the collector 20.

The attracting unit 102 is provided at an opposite side of where the nanofibers f are collected on the collector 20, that is an position side of where the nanofiber discharging apparatus 200 is provided. The attracting unit 102 is an apparatus which attracts gases forming the gas flow traveled from the nanofiber discharging apparatus 200 through the collector 20. In the present embodiment, the nanofiber producing apparatus 100 includes a blower, such as a sirocco fan or an axial flow fan, as the attracting unit 102. Further, the attracting unit 102 is provided inside the duct 121. The attracting unit 102 is capable of attracting the gas flow in which evaporated solvent is mixed, and also transporting the gas flow to the solvent collecting apparatus 106 through the duct 121.

The attraction control unit 105 is an apparatus which is electrically connected to the attracting unit 102, and which controls the attraction amount of the attracting unit 102. In the present embodiment, a blower is used as the attracting unit 102. The attraction control unit 105 controls the attraction amount of gas by controlling the number of rotation of the blower.

The area control unit 103 serves to control the attraction area of the attracting unit 102, and is provided at an opposite side of where the nanofibers f are collected on the collector 20, and provided between the collector 20 and the attracting unit 102. The area control unit 103 is a cylinder which has both ends which are opened. The area control unit 103 is preferably shaped such that it corresponds to the shape of the end of the nanofiber discharging unit 200 which discharges the nanofibers f. For example, when the end of the nanofiber discharging apparatus 200 has a rectangular shape, it is preferably that the area control unit 103 be a rectangular shaped cylinder. Further, when the end of the nanofiber discharging apparatus 200 has a circular cylindrical shape, it is preferable that the area control unit 103 also has a circular cylindrical shape.

The nanofiber discharging apparatus 200 is an apparatus which ejects the charged solution 11 into the air and produces the nanofibers f by causing electrostatic explosion in the air. The nanofiber discharging apparatus 200 includes an ejection unit 201, a charging unit 202, a solution supplying unit 204, a gas flow generating unit 38, a heating unit 205 and a guiding body 206.

Note that the raw material liquid to be used for producing the nanofibers f is referred to as the solution 11, and the produced nanofibers are referred to as the nanofibers f; however, the border between the solution 11 and the nanofibers f is ambiguous; and thus, they cannot be clearly distinguished from each other.

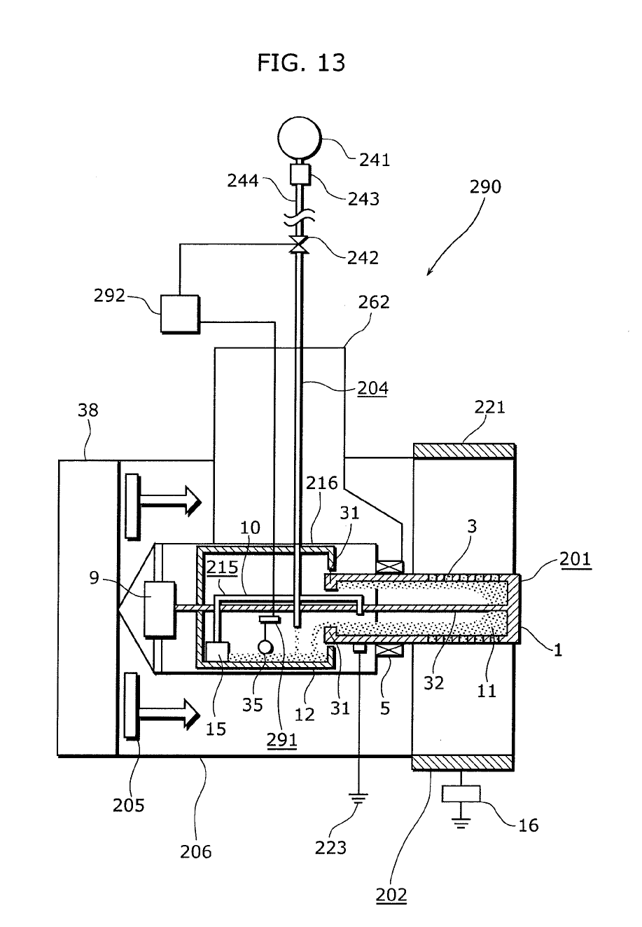

FIG. 13 is a cross-sectional view of a solution discharging unit.

Note that a solution discharging unit 290 is a collective term for members such as the ejection unit 201, the charging unit 202, the gas flow generating unit 38 (see below), the guiding body 206 (see below), the heating unit 205 (see below) and the like.

The ejection unit 201 is an apparatus which ejects the solution 11 into the air, and includes an ejection container 1, a rotary shaft 32, a motor 9, a solution storage unit 12, a transporting unit 215, and a windshield case 216.

The ejection container 1 is a container which can eject (discharge) the solution 11 into the air by the centrifugal force caused by rotation of the ejection container while the solution 11 being supplied inside. The ejection container 1 has a cylindrical shape whose one end is closed, and includes a plurality of ejection holes 3 on its circumferential wall. The ejection container 1 is formed of a conductive material so that an electric charge can be applied to the solution 11 contained inside. The ejection container 1 is pivotally supported by a bearing 5 provided to the support body 262. More particularly, it is preferable that the diameter of the ejection container 1 be set within a range of not less than 10 mm to not more than 300 mm. It is because, if the diameter is too large, causing the gas flow to concentrate the solution 11 or the nanofibers f becomes difficult. In addition, in order to stably rotate the ejection container, a stronger structure for supporting the ejection container is required. On the other hand, if the diameter is too small, it is necessary to increase rotation of the ejection container 1 so that the solution 11 is ejected by the centrifugal force. This causes problems associated with load of the motor, vibration or the like. Further, it is preferable that the diameter of the ejection container 1 be set within a range of not less than 20 mm to not more than 100 mm. Further, the cross-sectional shape of the ejection hole 3 is a circle. The diameter of the ejection hole 3 is preferably set within a range of not less than 0.01 mm to not more than 2 mm. However, the shape of the ejection hole 3 is not limited to circle, but may be polygonal, star like shape, or the like.

At the other end of the ejection container 1, an annular weir 31 is provided projecting inward from the circumference of the other end of the ejection container 1. The weir 31 is a wall which acts as a weir for storing a predetermined amount of the solution 11 inside the ejection container 1. When the amount of the solution 11 exceeding the predetermined amount is transported into the ejection container 1, the solution 11 overflows over the weir 31 from the other end of the ejection container 1.

The solution storage unit 12 is a container-shaped member which temporarily stores the solution 11 supplied to the ejection container 1, and serves as a receiving unit 13 for receiving the solution 11 overflowed the ejection container 1. The solution storage unit 12 is provided in the vicinity of the other end of the ejection container 1, that is, in the vicinity of the weir 31, and includes an opening for directly receiving the solution 11 overflowed over the weir 31. Further, in the present embodiment, the solution storage unit 12 has a cylindrical shape having a diameter larger than that of the ejection container 1, and is provided coaxially to the ejection container 1. The solution storage unit 12 is provided such that its top end overlaps the other end of the ejection container 1. With this, it is possible to collect the solution 11 overflowed not only to the bottom, but also to the top or side due to rotation of the ejection container 1. Furthermore, the base end of the solution storage unit 12 is closed except the hole into which the rotary shaft 32 is pivotally inserted.

The transporting unit 215 is an apparatus for transporting the solution 11 from the solution storage unit 12 to the ejection container 1. The transporting unit 215 includes a transporting pump 15 for pumping up the solution 11 from the solution storage unit 12, and a solution supply tube 10 for guiding the solution 11 to the ejection container 1. The transporting unit 215 may be a pump which constantly keeps transporting a predetermined amount of the solution 11; however, it may be a pump which includes a control unit which is capable of controlling the transporting amount per unit time in accordance with the storage amount of the solution 11 in the solution storage unit 12. Further, kinds of the transporting pump 15 are not particularly limited; and thus, any pumps such as a gear pump, tube pump or the like, can be used. Note that use of the tube pump is preferable, since it facilitates conducting the maintenance.

The windshield case 216 is a cylindrical box which prevents evaporation of the solution 11 stored in the solution storage unit 12 from being accelerated by the gas flow generated by the aforementioned gas flow generating unit 38, and also prevents the solution 11 flowing through the transporting unit 215 from being influenced by the gas flow. Such structure is particularly preferable in the case where the gas flow has high temperature due to heating, since the solution 11 in the transporting unit 215 can be protected from the high-temperature gas flow. The windshield case 216 has a tapered portion at one end for reducing resistance between the gas flow and the windshield case 216, so as to avoid disturbance of the gas flow as much as possible. Further, the windshield case 216 has a diameter larger than that of the ejection container 1, which prevents the gas flow from passing through the vicinity of the ejection holes 3. Accordingly, the solution 11 travels a predetermined distance from the ejection holes 3, and then hits the gas flow. As a result, the direction of travel of the solution 11 changes, which reduces the possibility of accelerating evaporation of the solution 11 in the vicinity of the ejection holes 3. Consequently, it is possible to avoid clogging of the ejection holes 3 caused by the solution 11 whose viscosity is increased under the influence of the gas flow in the vicinity of the ejection holes 3 or by the nanofibers f produced immediately after the ejection.

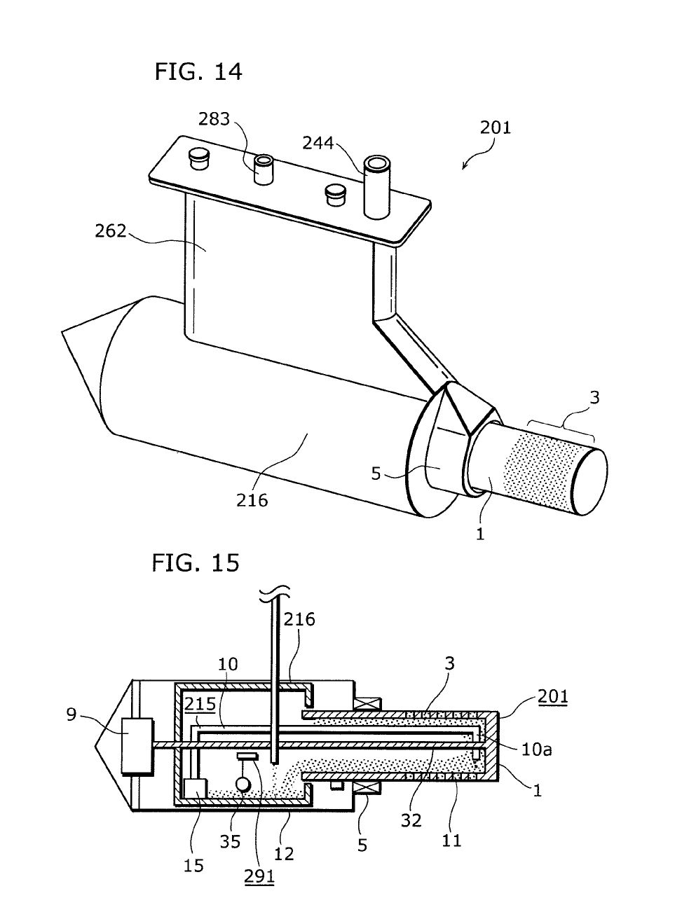

The solution supplying unit 204 is a unit for directly supplying the solution 11 to the solution storage unit 12, and includes a solution supply source 241, an adjusting valve 242 for adjusting the supply amount of the solution 11, a supply pump 243, and a supply tube 244 for guiding the solution 11. The solution supply source 241 is a tank for storing the solution 11. Further, the supply tube 244 passes through inside the support body 262 which supports the ejection unit 201 (see FIG. 14).

The rotary shaft 32 is a shaft which has a rod shape and transmits drive force for rotating the ejection container 1 from the motor 9. The rotary shaft 32 is inserted into the ejection container 1 through the other end of the ejection container 1, and is connected to the closed section of the one end of the ejection container 1.

The motor 9 is an apparatus which applies rotation drive force to the ejection container 1 via the rotary shaft 32 for ejecting the solution 11 through the ejection holes 3 by the centrifugal force. Note that because of the bores of the ejection holes 3 and the like, it is preferable that the number of rotation of the ejection container 1 be set within a range of not less than a few rpm to not more than 10000 rpm. When the ejection container 1 is directly driven by the motor 9 as in the present embodiment, the number of rotation of the motor 9 corresponds to the number of rotation of the ejection container 1.

The charging unit 202 is an apparatus which chares the solution 11 by applying an electric charge to the solution 11, and includes an induction electrode 221, a charge power source 16 and a grounding unit 223.

The induction electrode 221 is a member for inducing charges on the ejection container 1 which is provided in the vicinity of the induction electrode 221 and is grounded, by having a voltage higher than ground (by having a lower voltage in the case where the charge power source applies a negative voltage). The induction electrode 221 is an annular member provided so as to surround the tip of the ejection container 1. Accordingly, when a positive potential is applied to the induction electrode 221, a negative charge is induced on the ejection container 1, which results in applying a negative charge to the solution 11. On the other hand, when a negative potential is applied to the induction electrode 221, a positive charge is induced on the ejection container 1, thereby applying a positive charge to the solution 11. Further, the induction electrode 221 also serves as a guiding body 206 which guides gas flow from the gas flow generating unit 38.

The induction electrode 221 needs to be larger than the ejection container 1 in size. It is preferable that the diameter be set in the range from not less than 200 mm to not more than 800 mm. The shape of the induction electrode 221 is not limited to an annular shape, but the induction electrode 221 may be a polygonal shaped annular member. The induction electrode 221 only needs to be provided at a certain distance so as to surround the ejection container 1. The induction electrode 221 may be an annular metal wire or the like which surrounds the ejection container 1.

The charge power source 16 is a power source which can apply a high voltage to the induction electrode 221. The charge power source 16 is a DC power source, and an apparatus which can change voltage to be applied to the induction electrode 221 (with ground as a reference potential) or its polarity.

Preferable voltage to be applied by the charge power source 16 to the induction electrode 221 is set within the range from not less than 10 KV to not more than 200 KV. Especially, the electric field strength between the ejection container 1 and the induction electrode 221 is important; and thus, it is preferable to set a voltage to be applied or to arrange the induction electrode 221 such that the electric field strength is 1 KV/cm or more.

The grounding unit 223 is a member which is electrically connected to the ejection container 1 and maintains the ground potential of the ejection container 1, and serves as a ground. One end of the grounding unit 223 serves as a brush so that electric connection state can be maintained even when the ejection container 1 is in a rotating state. The other end is connected to the ground.

As in the present embodiment, by utilizing the induction method to the charging unit 202, an electric charge can be applied to the solution 11 while keeping the ground potential of the ejection container 1. When the ejection container 1 is in the ground potential state, it is not necessary that members, such as the rotary shaft 32, the motor 9, and the solution storage unit 12 which are connected to the ejection container 1, are electrically insulated from the ejection container 1. This allows a simple structure of the ejection unit 201.

Note that it may be that as a charging unit, the ejection container 1 is directly connected to a power source, and an electric charge is applied to the solution 11 while maintaining the high voltage of the ejection container 1. Further, it may be such that: the ejection container 1 is formed of insulating materials; an electrode which directly contacts the solution 11 stored in the ejection container 1, is provided inside the ejection container 1; and an electric charge is applied to the solution 11 by the electrode.

The gas flow generating unit 38 is an apparatus which generates gas flow for changing the direction of travel of the solution 11 ejected from the ejection container 1 into the desired direction of deposition of the nanofibers f. The gas flow generating unit 38 used in the present embodiment is a blower including an axial flow fan which forcibly blows surrounding atmosphere (air). The gas flow generating unit 38 is provided at the rear side of the motor 9 which rotates the ejection container 1, and generates gas flow directed the tip of the ejection container 1 from the direction of the motor 9. The gas flow generating unit 38 is capable of generating force which changes, into the axial direction of the ejection container 1, the direction of the solution 11 radically ejected by the centrifugal force from the ejection container 1.

The gas flow generating unit 38 may be made of other types of blowers, such as a sirocco fan. Further, the gas flow generating unit 38 may be a gas flow generating unit which changes the direction of the ejected solution 11 by introducing high pressure gas. In addition, the gas flow generating unit 38 may be a gas flow generating unit which generates gas flow to the inside of the guiding body 206 by the attracting unit 102, an aforementioned second gas flow generating unit 232, or the like. In this case, the gas flow generating unit 38 does not include an apparatus for actively generating gas flow; however, in the case of the present invention, it is considered that the gas flow generating unit 38 is included since gas flow is generated at a place close to the ejection container 1. Further, by attracting using the attracting unit 102 in a state where the gas flow generating unit 38 is not included, gas flow is generated inside the guiding body 206. This also be considered that the gas flow generating unit 38 is included. In FIG. 13, gas flows are indicated by arrows.

The guiding body 206 is an air channel having a function to guide gas flow generated by the gas flow generating unit 38 into a predetermined direction.

The heating unit 205 is a heating source which heats gas (safe gas) forming the gas flow generated by the gas flow generating unit 38. In the present embodiment, the heating unit 205 is an annular heater provided on the air path formed by the guiding body 206, and is capable of heating gas passes through the heating unit 205. By heating gas flow using the heating unit 205, evaporation of the solution 11 ejected into the space is accelerated, thereby effectively producing the nanofibers f.

Further, the nanofiber discharging apparatus 200 includes a solution amount detecting unit 291 and a supply amount control unit 292.

The solution amount detecting unit 291 is an apparatus which detects the storage amount of the solution 11 stored in the solution storage unit 12. The solution amount detecting unit 291 shown in FIG. 13 includes a float 293 floating in the solution 11. The solution amount detecting unit 291 is an apparatus which detects upper limit height and the lower limit height of the solution 11 stored in the solution storage unit 12 by the liquid surface sensor 35 which detects, by two limit switches (not shown), up and down movement of the float. As described, in the case where the shape of the solution storage unit 12 is known or can be measured, it is only necessary to simply detect the height of the liquid surface. The solution amount detecting unit 291 is not limited to the method above, but it may be a solution amount detecting unit which detects the height of the surface of the solution 11 linearly. Further, since the solution 11 is charged, it is preferable that the liquid amount detecting unit mechanically detects the liquid amount as the described floating type does.

The supply amount control unit 292 is an apparatus which controls an adjusting valve 242 in the solution supplying unit 204 based on the detection result of the solution amount detecting unit 291 such that the storage amount of the solution 11 is within a predetermined range. In the case where two detection results, which are the upper limit and the lower limit of the liquid surface of the solution 11, are transmitted from the solution amount detecting unit 291, the supply amount control unit 292 starts supplying the solution 11 when the liquid surface reaches the lower limit, and stops supplying the solution 11 when reaching the upper limit. Further, in the case where the detection result of the height of the liquid surface of the solution 11 is transmitted linearly, it may be that the supply amount control unit 292 performs calculation based on the height of the liquid surface and the supply amount, and adjusts opening of the adjusting valve 242 so that a constant liquid surface can be kept as much as possible. Note that examples of such control include a PID control.

Note that the supply amount control unit 292 may control supply amount by directly controlling the supply pump 243, instead of controlling the adjusting valve 242.

Accordingly, the solution 11 stored in the ejection container 1 can be kept to be an approximately constant amount. Therefore, condition of the solution 11 ejected through the ejection holes 3 can be stabilized, thereby stabilizing the quality of the produced nanofibers f. Further, the amount of the solution 11 stored in the solution storage unit 12 provided near the ejection container 1 is kept within a predetermined range, or at a predetermined amount. Therefore, it is possible to continuously supply the solution 11 stably without adversely affecting the amount of the solution 11 in the ejection container 1. In addition to those advantageous effects, circulation pathway of the solution 11, provided for keeping the constant amount of the solution 11 in the ejection container 1, has such a length that it cannot be shortened any further. Therefore, it prevents, as much as possible, degradation of the solution 11 caused by circulation of the solution 11. As a result, it is possible to stabilize quality of the produced nanofibers at a high level.

More particularly, the ejection container 1 often rotates at a high speed of 1000 rpm or more. In the case where the ejection container 1 contains a large amount of solution 11, uneven rotation or shift of the rotary shaft causes the ejection container 1 to rotate improperly, which largely contributes to the breakdown of the apparatus.

FIG. 14 is a perspective view of an appearance of an ejection unit.

The support body 262 is a member for supporting the ejection unit 201, and provided between the ejection holes 3 and the gas flow generating unit 38. The support body 262 has a thickness smaller than the diameter of the ejection container 1 in a vertical direction with respect to the direction of flow of the gas flow generated by the gas flow generating unit 38. The support body 262 has a long shape extending along the direction of gas flow. Such shape is for strongly supporting the ejection unit 201 while preventing disturbance of the gas flow as much as possible. Further, the support body 262 has an end that is at the upstream side of the gas flow, and the other end that is at the downstream side of the gas flow, which both have a streamline shape. Having the streamline shape in such a manner further prevents the disturbance of the gas flow.

Further, the support body 262 includes a supply tube 244 for supplying the solution 11 to the solution storage unit 12 inside. The support body 262 further includes an insertion hole 283 into which a conductive wire or the like for supplying electric power to the motor 9 is inserted. By including the supply tube 244, and the insertion hole 283 inside the support body 262 in such a manner, it is possible to prevent the disturbance of the gas flow generated by the gas flow generating unit 38.

Further, the support body 262 includes a bearing 5 at its bottom end edge. The bearing 5 pivotally supports the ejection container 1 at the bottom end edge f the support body 262.

Now, reference is returned to FIG. 12.

The air channel 265 is a member which forms an air channel for guiding the solution 11 or the nanofibers f discharged from the solution discharging unit 290 such that they pass through a predetermined travel path. The air channel 265 includes, at its base end, an inlet opening for receiving, together with the gas flow generated by the gas flow generating unit 38, the solution 11 or the nanofibers f discharged from the solution discharging unit 290. Following the inlet opening, the air channel 265 includes an electrostatic explosion area where a space is formed in which the solution 11 undergoes sufficient electrostatic explosions so that the nanofibers f are produced. Further, following the electrostatic explosion area, the air channel 265 includes a charge neutralization area where a space is formed in which the charges of the nanofibers f, produced by the electrostatic explosion and still being in charged states, are neutralized. The charge neutralization area may have a length long enough for the charges of the nanofibers f to be naturally neutralized. Further, the charge neutralization area may include a charge neutralizer 207 for forcibly neutralize the charges of the nanofibers f.

The charge neutralizer 207 is an apparatus which forcibly neutralizes the charged nanofibers f, and discharges, into a space, ions or particles having a polarity opposite to that of the charged nanofibers f. More specifically, the charge neutralizer 207 may utilize any types of methods, such as a corona discharge type, voltage applying type, AC type, stationary DC type, pulsed DC type, self discharge type, soft x-ray type, ultraviolet ray type, and radiation type.

Following the charge neutralization area, the air channel 265 includes a narrowing area whose bore (area) gradually narrows from upstream side to downstream side of the gas flow. The narrowing area has a tapered shape which improves density of the nanofibers f that are present in the space. Each of the upstream side and the downstream side of the gas flow in the narrowing area includes a gas flow inlet 233. The gas flow inlet 233 is connected to the second gas flow generating unit 232, and is an opening for guiding rapid gas flow into the air channel 265. Each of the gas flow inlets 233 is provided toward a direction that the gas flow can be ejected from the larger bore side to the smaller bore side of the narrowing area.

The second gas flow generating unit 232 is an apparatus which generates gas flow by introducing high pressure gas into the air channel 265. More specifically, an example of the second gas flow generating unit 232 is an apparatus which includes a tank (cylinder) which can store high pressure gas, a pump for forcibly introducing gas into the tank, and a gas introducing unit having a valve for adjusting pressure of high pressure gas in the tank.

Note that the gas supplied by the second gas flow generating unit 232 may be air, but preferably safe gas which has oxygen content ratio lower than that of air. This is to avoid explosion due to solvents evaporated from the solution 11. Examples of the safe gas include low oxygen concentration gas, in which a certain amount of oxygen is removed from air by using a resin film (hollow fiber membrane), and superheated steam. The description here does not exclude the use of high purity gas which hardly contains oxygen, but, for example, high purity nitrogen sealed in a cylinder in the form of liquid or gas, or carbon dioxide supplied from dry ice may also be used.

Further, a heating unit may be provided for heating gas flow generated by the second gas flow generating unit 232.

Next, outlines of a method for producing the nanofibers f and a method for producing nonwoven fabric will be described.

First, the gas flow generating unit 38 generates gas flow into the solution discharging unit 290 and the guiding body 206. At the same time, the attracting unit 102 attracts the gas flow from a position which is farther downstream than the collector 20.

Next, the solution 11 is supplied into the solution storage unit 12, and is transported from the solution storage unit 12 to the ejection container 1. Next, the solution 11 stored in the ejection container 1 is electrically charged by the charge power source 16, and the ejection container 1 is rotated by the motor 9, so that the charged solution 11 is ejected through the ejection holes 3 by the centrifugal force.

The ejected solution 11 is changed its direction of travel by the gas flow. As a result, the ejection holes 3 can be arranged vertically or substantially vertically to the deposition surface of the nanofibers f, thereby ejecting a large amount of solution 11 into a certain space. Further, since the gas flow is heated, evaporation of solvents is accelerated, which results in acceleration of electrostatic explosion. As a result, it is possible to effectively produce the nanofibers f.

Here, the windshield case 216 prevents the gas flow from reaching the ejection holes 3 or near the ejection holes 3. This makes a state where evaporation of the solvents included in the solution 11 is not easily accelerated near the ejection holes 3. As a result, narrowing and blocking the ejection holes 3 by the solute are prevented. Therefore, it is possible to suppress reduction of the ejection amount as much as possible, even if the solution 11 is continuously ejected from the ejection container for a long period of time. More specifically, it is possible to maintain the concentration of the solution 11 or the nanofibers f in the air at a high state for a long period of time.

Then, the produced nanofibers f are transported in the air channel 265 with the gas flow, and reaches the collector 20 while being in the high density state. The collector 20 serves as a filter, since the gas flow is attracted by the attracting unit 102 from the rear side (downstream side). The collector 20 separates the nanofibers f and the gas flow, and collects only the nanofibers f while depositing the nanofibers f thereon. The collector 20 on which the nanofibers f are deposited is moved at a predetermined moving speed by the winding of the transporting unit 104. The nanofibers f deposited on the collector 20 is moved together with the collector 20 while forming a nonwoven fabric, and wound by the transporting unit 104.

Accordingly, the nanofiber producing apparatus 100 according to the present embodiment is capable of stably producing high quality nanofibers f. In addition, it is possible to make a state where the concentration of the solution 11 or the produced nanofibers f in the air is high and even, and also to collect the nanofibers f in such a high concentration state. Accordingly, it is possible to stably collect the nanofibers f in a thick and long non-woven fabric state with high quality.

Note that in the present embodiment, the support body 262 supports the ejection unit 201 in a hanging state; however, the present invention is not limited thereto. For example, it may be that the support body 262 is attached to the floor or the like, and supports the ejection unit 201 such that the ejection unit 201 is placed thereon.

Further, in the above embodiment, the supply amount of the solution 11 is controlled by detecting the solution storage amount of the solution storage unit 12; however, it may be that the amount of the solution 11 ejected from the ejection holes 3 is predicted, and the amount of the solution 11 which is approximately same amount of the predicted consumption amount is continuously supplied from the solution supply unit 204.

FIG. 15 is a cross-sectional view of a variation of the ejection unit.

As shown in FIG. 15, the cylindrical ejection container 1 having a closed one end, does not have a weir on its other end. Therefore, the diameter of the inside of the ejection container 1 is same from one end to the other end. Further, the solution supply tube 10 of the transporting unit 215 is inserted into the ejection container 1, and has a discharging portion 10a at the tip. The discharging portion 10a is positioned near the closed end of the ejection container 1.

Therefore, in the ejection container 1 according to the present variation 1, the solution 11 is supplied to the innermost portion of the ejection container 1. Then, the solution 11 overflows along the inner circumferential surface of the ejection container 1 through the opening (some of the solution 11 is discharged through the ejection holes 3). Therefore, resistance due to the weir does not occur when the solution 11 overflows.

It is preferable that such structure is applied, for example, to the solution 11 having a high viscosity. This is because, in the case of the high-viscosity solution 11, it is possible to form a layer of the solution 11 with a desired thickness on the inner circumferential surface of the ejection container 1 due to the centrifugal force caused by rotation of the ejection container 1, even without the weir.

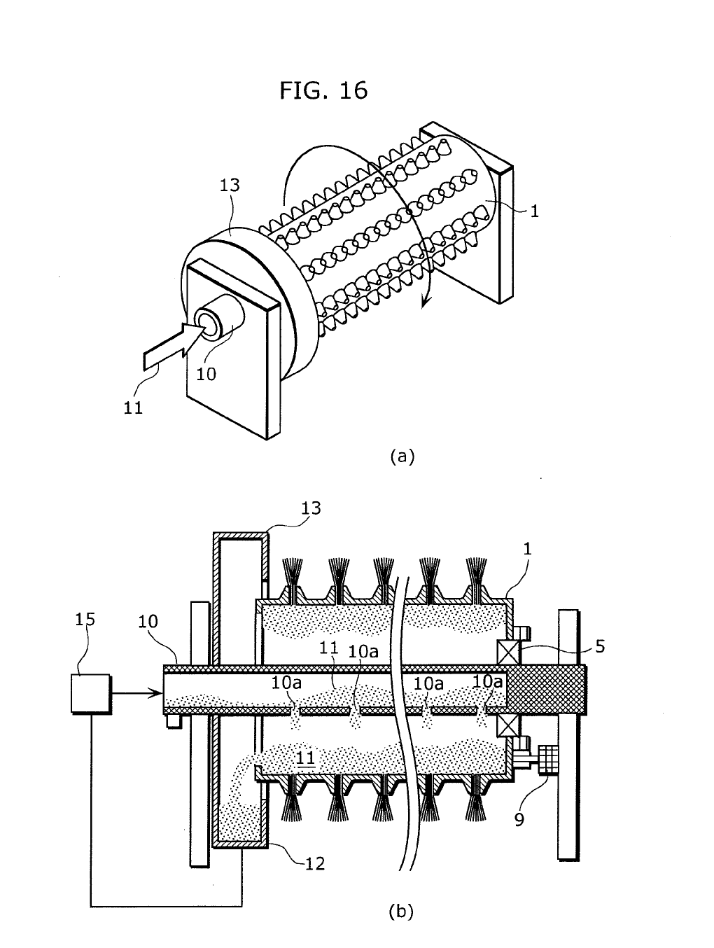

FIG. 16 is a cross-sectional view of another variation of the ejection unit.

As shown in FIG. 16, the ejection container 1 is pivotally attached to the solution supply tube 10 which is fixedly arranged. Further, the solution supply tube 10 includes a plurality of discharging portions 10a.

With the above structure, it is possible to supply the solution 11 evenly in the longitudinal direction of the ejection container 1. Such a structure is preferable especially when the ejection container 1 is long.

### INDUSTRIAL APPLICABILITY

According to a nanofiber producing method and apparatus of the present invention, the amount of solution in an ejection container can be always maintained to be constant by allowing the amount of the solution exceeding a predetermined amount in the ejection container to overflow, and simply supplying a sufficient amount of the solution. Therefore, centrifugal force acts on the solution discharged through ejection holes of the ejection container can be made constant, and uniform nanofibers can be always produced. As a result, the method and apparatus can be preferably used for producing, with high productivity, high quality nanofibers that are preferably applied to a filter, a separator for use in a battery, a polymer electrolyte membrane or an electrode for use in a fuel cell, or the like.

1. A nanofiber producing method including: supplying solution which is raw material liquid into an ejection container which is conductive and has a plurality of ejection holes, the raw material liquid being prepared by dissolving a polymeric substance in a solvent; and rotating the ejection container so that the solution discharged through the plurality of ejection holes is electrostatically exploded, said nanofiber producing method comprising, in the case where an amount of the solution contained in the ejection container exceeds a predetermined amount:
allowing an amount of the solution exceeding the predetermined amount to overflow the ejection container;
collecting the solution which has overflowed; and
resupplying the solution which has been collected to the ejection container.

2. The nanofiber producing method according to claim 1,
wherein the ejection container is a cylindrical container and has the plurality of ejection holes on a circumferential wall, and
said method further comprises
allowing the amount of the solution exceeding the predetermined amount to overflow through a weir which has an annular shape and is provided at one end of the ejection container.

3. A nanofiber producing apparatus comprising:
an ejection unit configured to eject solution which is raw material liquid for nanofibers; and
a charging unit configured to charge the solution by applying an electric charge to the solution,
wherein said ejection unit includes:
an ejection container which has a cylindrical shape with an ejection hole on a circumferential wall and ejects the solution contained inside by a centrifugal force caused by rotation of said ejection container;
a solution storage unit configured to store the solution to be transported to said ejection container, and to store the solution which has overflowed said ejection container; and
a transporting unit configured to transport the solution from said solution storage unit to said ejection container.

4. The nanofiber producing apparatus according to claim 3,
wherein said ejection container includes a weir which has an annular shape and is provided on an inner circumferential surface of an end of said ejection container, said weir projecting inward said ejection container.

5. The nanofiber producing apparatus according to claim 3, further comprising
a gas flow generating unit provided at a distance from said ejection container in an axial direction of said ejection container.

6. The nanofiber producing apparatus according to claim 5, further comprising
a windshield case, inside which said solution storage unit and said transporting unit can be provided, and which prevents gas flow generated by said gas flow generating unit from flowing into inside of said windshield case.

7. The nanofiber producing apparatus according to claim 5, further comprising
a guiding body which guides gas flow for transporting the solution which has been ejected or the nanofibers which have been produced,
wherein said solution storage unit is provided inside said guiding body.

8. The nanofiber producing apparatus according to claim 3,
wherein said ejection unit includes a case for holding said ejection container which rotates, and
said solution storage unit is provided inside said case.
